(19) United States
(12) Patent Application Publication
(10) Pub. No.: US 2017/0060147 A1
(43) Pub. Date: Mar. 2, 2017

(54) BACK PRESSURE CONTROL REGULATOR WITH IN-LINE OVERPRESSURE RELIEF

(71) Applicant: TESCOM CORPORATION, Elk River, MN (US)

(72) Inventor: Gordon C. Muir, Maple Grove, MN (US)

(21) Appl. No.: 15/239,292

(22) Filed: Aug. 17, 2016

Related U.S. Application Data
(60) Provisional application No. 62/208,922, filed on Aug. 24, 2015.

(51) Int. Cl. G05D 16/10; F16K 31/122; F16K 17/02; F16K 27/02

(52) U.S. Cl. CPC G05D 16/103; F16K 27/02; F16K 31/1221; F16K 31/1225; F16K 31/1223; F16K 17/02

(57) ABSTRACT

A back pressure regulator with in-line over pressure relief includes a first pressure regulator and a second pressure regulator arranged fluidly in parallel, which are connected by a common regulator housing.

### FIELD OF THE DISCLOSURE

The disclosure generally relates to back pressure control regulators and more specifically to back pressure control regulators with in-line overpressure relief.

### BACKGROUND OF THE DISCLOSURE

Process control systems commonly employ pressure regulators (e.g., back-pressure regulators) to control or maintain a pressure of a process fluid to protect instruments or other control devices that are sensitive to high pressures. Fluid regulators, such as, for example, back-pressure regulators, typically include a fluid valve assembly having a pressure sensor such as a piston to sense the pressure of a pressurized fluid at an inlet of the regulator. When the pressure of the pressurized fluid at the inlet exceeds a reference or set-point pressure (e.g., provided by the fluid regulator), the pressure sensor causes a flow control member of the fluid valve to open to allow fluid flow through the regulator body between the inlet and an outlet.

Back pressure regulators are designed to maintain fluid back pressure in a system within a set range. If back pressure in the system exceeds the set range, internal regulator components can be damaged. For this reason, most systems having back pressure regulators include a pressure relief valve located downstream of the back pressure regulator to prevent internal pressure from exceeding design limits of the back pressure regulator components.

However, incorporating a pressure relief valve into a system is a costly solution. Additionally, some systems frequently experience transitory fluid pressure excursions above the design limits of the back pressure regulator, such as when a downstream component, such as a valve, closes. These frequent transitory pressure excursions, while not significant enough to damage the back pressure regulator components, are often significant enough to activate the pressure relief valve. As a result, the pressure relief valve may be actuated often when it is not actually needed. Thus, pressure relief valves in this situation wear out prematurely, causing additional costs. Moreover, downstream pressure relief valves include many additional leak paths, which increase the possibility of fluid leakage.

### SUMMARY OF THE DISCLOSURE

According to some aspects, the back pressure regulators described herein provide safety protection for a first or primary pressure regulator from transient fluid pressure fluctuations that exceed a desired maximum fluid pressure while reducing wear and tear on downstream pressure relief valves by reducing the frequency of activation due to transient fluid overpressure situations. Additionally, the disclosed back pressure regulators may reduce the number of system components, which reduces the number of potential leak paths and thus the number of potential fluid leaks.

In one exemplary arrangement, a back pressure regulator includes a first pressure regulator and a second pressure regulator arranged fluidly in parallel and connected by a common regulator housing.

In accordance with the teachings of the disclosure, any one or more of the foregoing aspects and/or exemplary aspects of a back pressure regulator may further include any one or more of the following optional forms.

In some optional forms, the first pressure regulator has a first flow capacity and the second pressure regulator has a second, higher flow capacity.

In yet other optional forms, the second pressure regulator is activated at or above a maximum fluid pressure setting of the first pressure regulator.

In yet other optional forms, the common regulator housing includes a fluid inlet and a fluid outlet, a first pressure regulator passageway, and a second pressure regulator passageway. In some forms, the first pressure regulator passageway has a lower flow capacity than the second pressure regulator passageway. In yet other forms, the first pressure regulator passageway has a flow capacity of about 50 SCFM at about 1800 psi to about 100 SCFM at about 2300 psi.

In yet other optional forms, the first pressure regulator passageway has a first pressure regulator inlet having a first cross-sectional area, and the second pressure regulator passageway has a second pressure regulator inlet having a second cross-sectional area, and the second cross-sectional area is larger than the first cross-sectional area.

In yet other optional forms, the first pressure regulator passageway includes a first pressure regulator outlet, and the first pressure regulator outlet has a cross-sectional area that is larger than the first pressure regulator inlet.

In yet other optional forms, the second pressure regulator passageway includes a second pressure regulator outlet, and the second pressure regulator outlet has a cross-sectional area that is approximately equal to the cross-sectional area of the second pressure regulator inlet.

In yet other optional forms, the first pressure regulator includes a first biasing element and the second fluid pressure regulator includes a second biasing element, and the first biasing element produces a lower biasing force than the second biasing element.

In yet other optional forms, the first pressure regulator is located on an opposite side of the regulator housing from the second pressure regulator.

In yet other optional forms, a maximum pressure of the second pressure regulator is approximately 10% higher than the maximum pressure of the first pressure regulator. In some optional forms, the first pressure regulator regulates pressure to between about 6,000 psi and about 10,000 psi and the second pressure regulator regulates pressure to between about 10,000 psi and about 11,000 psi.

In yet other optional forms, a fluid flow system includes the disclosed back pressure regulator and a pressure relief valve located downstream of the back pressure regulator

### BRIEF DESCRIPTION OF THE DRAWINGS

FIG. 1 is a plan view of a back pressure regulator having an in-line overpressure relief;

FIG. 2 is a longitudinal cross-sectional view of the back pressure regulator of FIG. 1;

FIG. 3 is a close-up longitudinal cross-sectional view of area “B” in FIG. 2; and

FIG. 4 is a close-up longitudinal cross-sectional view of area “C” in FIG. 2;

While the disclosure is susceptible to various modifications and alternative constructions, certain illustrative embodiments thereof have been shown in the drawings and will be described below in detail. It should be understood, however, that there is no intention to limit the disclosure to the specific forms disclosed, but on the contrary, the intention is to cover all modifications, alternative constructions, and equivalents falling within the spirit and scope of the invention.

### DETAILED DESCRIPTION

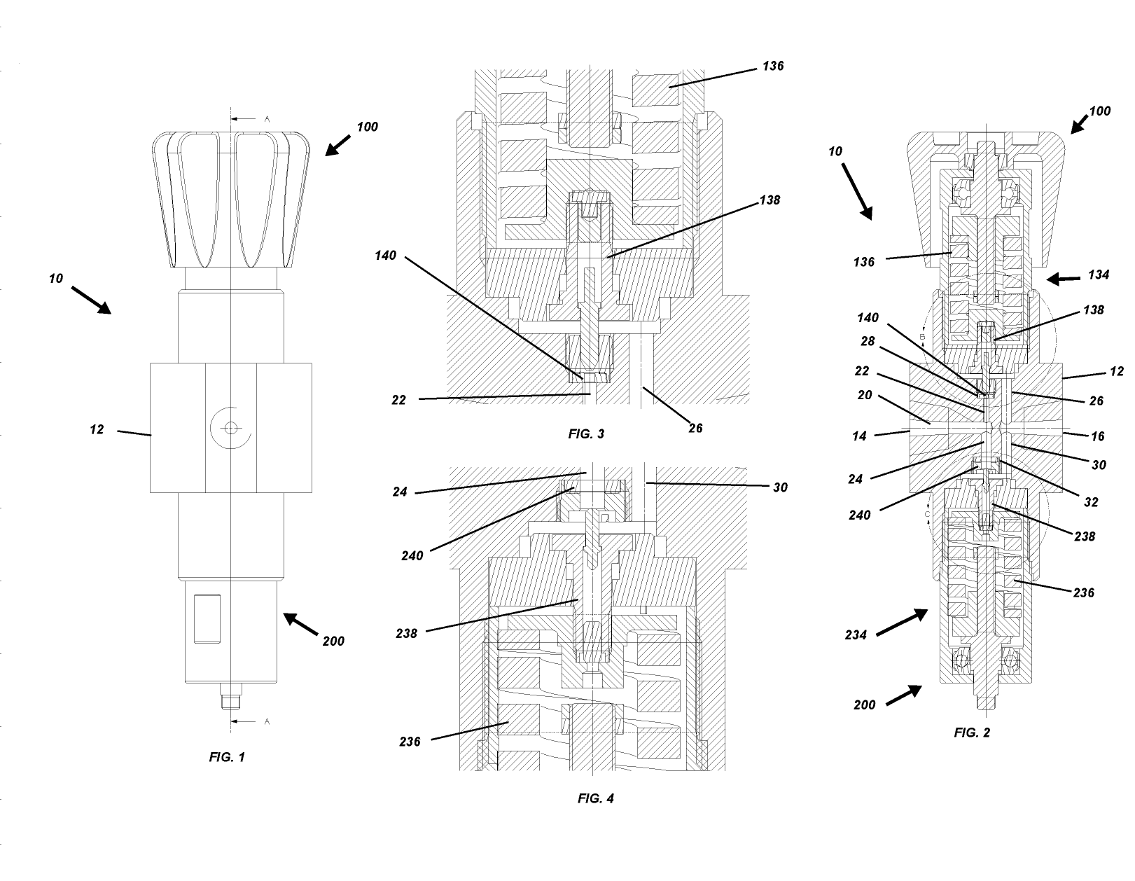

Turning now to FIG. 1, one embodiment of a back pressure regulator 10 with in-line pressure relief is illustrated. The back pressure regulator 10 may be operatively connected to a fluid flow path in a system to control back pressure within the system. In some cases, the fluid flow path may include an optional downstream pressure relief valve (not shown in the figures). The back pressure regulator 10 includes a first pressure regulator 100 and a second pressure regulator 200 that are connected in parallel to one another by a common regulator housing 12. In the embodiment illustrated in FIGS. 1-4, the first pressure regulator 100 is located on an opposite side of the housing 12 from the second pressure regulator.

Generally, the first pressure regulator 100 regulates fluid pressure within the system between a desired minimum back pressure and a desired maximum back pressure. The second pressure regulator 200 regulates fluid pressure within the system to a higher range when fluid pressure in the system exceeds the desired maximum back pressure of the first pressure regulator 100. For example, in one embodiment, the first pressure regular 100 has a minimum back pressure of 6,000 psi and a maximum back pressure of 10,000 psi. If system pressure exceeds 10,000 psi, the second pressure regulator 200 attempts to regulate fluid pressure between a second minimum back pressure (e.g., 10,000 psi) and a second maximum back pressure (e.g., 11,000 psi). This higher but narrower second fluid pressure range, which is regulated by the second pressure regulator 200, acts as a shock absorber in that transient back pressure spikes above 10,000 psi can be regulated without activating a downstream pressure relief valve. In this manner, the second pressure regulator 200 reduces wear and tear on downstream pressure relief valves (because these valves are not activated as often) while protecting internal components of the first pressure regulator 100 (e.g., by limiting maximum system pressure to only 10% above the desired maximum in this embodiment).

More specifically, as fluid pressure exceeds the maximum fluid pressure setting of the first fluid pressure regulator 100, the second fluid pressure regulator 200 begins to open, which creates an alternate fluid flow passageway. As a result, the second fluid pressure regulator 200 provides an increased flow rate capacity at or above the maximum fluid pressure setting of the first fluid pressure regulator 100. Thus, the capability of the first fluid pressure regulator 100 to regulate system fluid pressure near the maximum pressure can be extended while providing safety pressure protection for components of the first fluid pressure regulator 100 and while preventing premature actuation of any downstream pressure relief valves.

Turning now to FIGS. 2-4, the first pressure regulator 100 is fluidly connected to a fluid inlet 14 and to a fluid outlet 16 by the regulator housing 12. Similarly, the second pressure regulator 200 is fluidly connected to the fluid inlet 14 and to the fluid outlet by the regulator housing 12. The fluid inlet 14 includes an inlet flow path 20 that branches into a first pressure regulator inlet 22 and a second pressure regulator inlet 24. The first pressure regulator inlet 22 leads to a first pressure regulator outlet 26 through a first pressure regulator throat 28. In one example, the cross-sectional area of the first pressure regulator inlet 22 is smaller than the cross-sectional area of the first pressure regulator outlet 26. The second regulator inlet 24 leads to a second pressure regulator outlet 30 through a second pressure regulator throat 32. In one example, the cross-sectional area of the second pressure regulator outlet 30 is approximately equal to the cross-sectional area of the second pressure regulator inlet 24.

The first pressure regulator 100 includes an actuator 134 that has a first biasing element 136, such as a biasing spring, that biases a first valve stem 138 towards the first pressure regulator inlet 22. A control element, such as a first plug 140, is attached to the first valve stem 138 and moves with the first valve stem 138 in response to the first biasing element 136.

The second pressure regulator 200 includes an actuator 234 that has a second biasing element 236, such as a biasing spring, that biases a second valve stem 238 towards the second pressure regulator inlet 24. A control element, such as a second plug 240, is attached to the second valve stem 238 and moves with the second valve stem 238 in response to the second biasing element 236.

The biasing force produced by the first biasing element 136 is generally less than the biasing force produced by the second biasing element 236 so that the second pressure regulator 200 activates at a higher back pressure value than the first pressure regulator 100.

Additionally, the second regulator inlet 24 is larger (e.g., has a greater cross-sectional area) than the first regulator inlet 22 so that the second regulator inlet 24 can accommodate higher flow rates of fluid that the first regulator inlet 22. As a result, when the fluid back pressure in a system exceeds the setpoint for maximum back pressure of the first pressure regulator 100, the second pressure regulator 200 begins to open and fluid flowing through the second regulator inlet 24 allows the fluid pressure to remain at or near the setpoint for maximum back pressure for the first pressure regulator 100 for a longer period of time.

In one example, the back pressure regulator initially allows back pressure in the system to build to a first setpoint (e.g., approximately 1700 psi). The first pressure regulator regulates the back pressure between the low pressure or first setpoint and a high pressure or second setpoint. As pressure builds, the first pressure regulator allows greater flow rates of fluid to pass through, for example by the flow rate increasing from about 50 SCFM at about 1800 psi to about 100 SCFM at about 2300 psi. Above the second setpoint, the second pressure regulator begins to open, allowing greater flow rates of fluid with a slower rate of increase in pressure.

The back pressure regulators described herein advantageously provide safety protection for a first or primary pressure regulator from transient fluid pressure fluctuations that exceed a desired maximum fluid pressure while reducing wear and tear on downstream pressure relief valves by reducing the frequency of activation due to transient fluid overpressure situations. Additionally, the disclosed back pressure regulators may reduce the number of system components, which reduces the number of potential leak paths and thus the number of potential fluid leaks.

Although certain back pressure regulators have been described herein in accordance with the teachings of the present disclosure, the scope of the appended claims is not limited thereto. On the contrary, the claims cover all embodiments of the teachings of this disclosure that fairly fall within the scope of permissible equivalents.

1. A back pressure regulator comprising:
a first pressure regulator and a second pressure regulator arranged fluidly in parallel and connected by a common regulator housing.

2. The back pressure regulator of claim 1, wherein the first pressure regulator has a first flow capacity and the second pressure regulator has a second, higher flow capacity.

3. The back pressure regulator of claim 1, wherein the second pressure regulator is activated at or above a maximum fluid pressure setting of the first pressure regulator.

4. The back pressure regulator of claim 1, wherein the common regulator housing includes a fluid inlet and a fluid outlet, a first pressure regulator passageway, and a second pressure regulator passageway.

5. The back pressure regulator of claim 4, wherein the first pressure regulator passageway has a lower flow capacity than the second pressure regulator passageway.

6. The back pressure regulator of claim 5, wherein the first pressure regulator passageway has a flow capacity of about 50 SCFM at about 1800 psi to about 100 SCFM at about 2300 psi.

7. The back pressure regulator of claim 4, wherein the first pressure regulator passageway has a first pressure regulator inlet having a first cross-sectional area, and the second pressure regulator passageway has a second pressure regulator inlet having a second cross-sectional area, the second cross-sectional area being larger than the first cross-sectional area.

8. The back pressure regulator of claim 7, wherein the first pressure regulator passageway includes a first pressure regulator outlet, the first pressure regulator outlet having a cross-sectional area that is larger than a cross-sectional area of the first pressure regulator inlet.

9. The back pressure regulator of claim 8, wherein the second pressure regulator passageway includes a second pressure regulator outlet, the second pressure regulator outlet having a cross-sectional area that is approximately equal to the cross-sectional area of the second pressure regulator inlet.

10. The back pressure regulator of claim 1, wherein the first pressure regulator includes a first biasing element and the second pressure regulator includes a second biasing element.

11. The back pressure regulator of claim 10, wherein the first biasing element produces a lower biasing force than the second biasing element.

12. The back pressure regulator of claim 1, wherein the first pressure regulator is located on an opposite side of the regulator housing from the second pressure regulator.

13. The back pressure regulator of claim 1, wherein a maximum pressure of the second pressure regulator is approximately 10% higher than the maximum pressure of the first pressure regulator.

14. The back pressure regulator of claim 11, wherein the first pressure regulator regulates pressure to between about 6,000 psi and about 10,000 psi and the second pressure regulator regulates pressure to between about 10,000 psi and about 11,000 psi.

15. A fluid flow system including the back pressure regulator of claim 1 and a pressure relief valve located downstream of the back pressure regulator of claim 1.
